(19) United States
(12) Patent Application Publication
(10) Pub. No.: US 2008/0075513 A1
(43) Pub. Date: Mar. 27, 2008

(54) Methods for a Maintenance Algorithm in Hand Held Printers

(76) Inventors: Douglas Laurence Robertson, Crestwood, KY (US); Barry Baxter Stout, Lexington, KY (US); Randal Scott Williamson, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/535,199

(22) Filed: Sep. 26, 2006

(51) Int. Cl. B41J 3/36

(52) U.S. Cl. 400/88

(57) ABSTRACT

Methods and apparatus for monitoring the print quality maintenance of hand-held printers and insuring the performance of periodic maintenance to maintain optimal print quality.

### FIELD OF THE DISCLOSURE

The disclosure relates to several different methods for monitoring the maintenance of hand-held printers in order to perform periodic maintenance at the correct times to maintain optimal print quality, and in particular to insure that the hand-held printer user is alerted to perform a maintenance cycle before print quality is sacrificed.

### BACKGROUND OF THE INVENTION

One of the most challenging aspects of hand-held printers besides navigation is performing maintenance at the correct time to maintain optimal print quality. Present day hand-held printers, such as thermal printers, energize heaters in the printhead nozzles to eject ink. As is known, many nozzles on a printhead are not utilized at a particular time depending upon the printing scenario, and prolonged periods of non-use are detrimental to the operation of the printhead nozzle. In addition, as use increases, ink residue accumulates on the surface of the printhead nozzle plate. If such residue is not removed the residue can build up to a point where it interferes with the paper resulting in smearing of the printed image. To properly maintain the printhead, it is necessary to wipe the nozzle plate and eject ink through the printhead nozzles, the latter process being referred to as “exercising” or “spitting” the nozzles.

In typical stationary ink jet printers a built-in maintenance station performs such a cleaning operation at predefined periods, and at a cleaning station which also protects the printing apparatus from drying out during periods of non-use. However, with a hand-held printer, the print swath and the attendant maintenance period required to maintain print quality is much more difficult to formulate and maintain. Because of the unpredictable nature inherent to the use of a hand-held printer, wherein the printer motion and maintenance cycles are so dependent upon the operator, special considerations must be developed to insure that the hand-held printer and, therefore, the attendant print quality is maintained. Accordingly, this invention is directed to several methods of informing a user of a hand-held printer that such maintenance should be performed.

One important consideration in maintaining print quality for a hand-held printer is that the user must be alerted that such maintenance is required so that the hand-held printer can be applied to a docking or non-docking type maintenance system. For examples a separate docking station may be utilized wherein the user manually inserts the hand-held printer into such a docking station to perform the requisite maintenance. In another instance, a maintenance station may be built into the hand-held printer to be either automatically or manually activated. Either way, it is imperative for printhead maintenance that the user performs a maintenance cycle on the hand-held printer before print quality is sacrificed.

### BRIEF DESCRIPTION OF THE DRAWINGS

Further features and advantages of the disclosed embodiments may become apparent by reference to the detailed description when considered in conjunction with the figures wherein like reference numbers indicate like elements throughout and wherein:

FIG. 1 is a representation of a hand-held printer of the type which can incorporate the improvement described herein;

FIG. 2 is a mechanical schematic of a hand-held printer having an integral print maintenance system;

FIG. 3 is a mechanical schematic of a hand-held printer which utilizes a separate docking station for print maintenance;

FIG. 4 is a state flow diagram of the method for monitoring the maintenance of hand-held printers when the printer is in an idle state prior to beginning printing;

FIG. 5 is a state flow diagram illustrating the method for monitoring maintenance when the printer is printing;

FIG. 6 is a state flow diagram illustrating the method for monitoring when the printer is beginning a new page even if only partially through a print job; and

FIG. 7 is a state flow diagram when using a docking station for performing the requisite maintenance.

### SUMMARY OF THE INVENTION

With regard to the foregoing and after objects and advantages, the invention provides a method of maintaining the print quality of a hand-held printer by alerting the user that preventive maintenance is required. Such maintenance can be effected by activation of an integral maintenance system wherein the printhead nozzle plate is wiped or brushed and/or printhead ink is ejected from the printhead nozzles, or by placing the hand-held printer in a docking station wherein such maintenance is performed.

### DETAILED DESCRIPTION OF EXEMPLARY EMBODIMENTS

To insure that print quality is maintained, one of the biggest challenges for hand-held printer maintenance is insuring that the user does perform such requisite maintenance. Such maintenance notification may be visual, audible, or tactile, such as causing the hand-held printer to vibrate in the user's hand. Once the user is alerted, it would be beneficial if the print function of the hand-held printer would be temporarily disabled until the user performed the requisite maintenance. This maintenance could be performed at a separate docking station used to dock the printer, or within an integral maintenance system. With an integral maintenance station, the band-held printer could perform maintenance whenever needed, only relying on the user to stop printing. With a separate docking station the printer would be applied to the station before maintenance could be performed.

One of the crucial times to perform maintenance on a hand held printer is before the start of a print job. Accordingly, it is preferable that the print function would be deactivated until preventive maintenance is performed. With the use of a separate docking station, the printer can be locked into the docking station until the operator performs a physical movement initiating the performance of the requisite maintenance. Alternatively, an electronic locking device may be used to prevent the user from removing the printer from the docking station until the proper maintenance is performed. This may be either a manually or electronically control release.

As for hand-held printers having an integral maintenance station, the maintenance cycle would engage periodically when the printer is lifted to begin use. In this manner maintenance of the printhead nozzles and printhead nozzle plate would be initiated when such maintenance was necessary to maintain print quality. The basic requisite would be to force the user to perform the maintenance when necessary, especially at the start of printing.

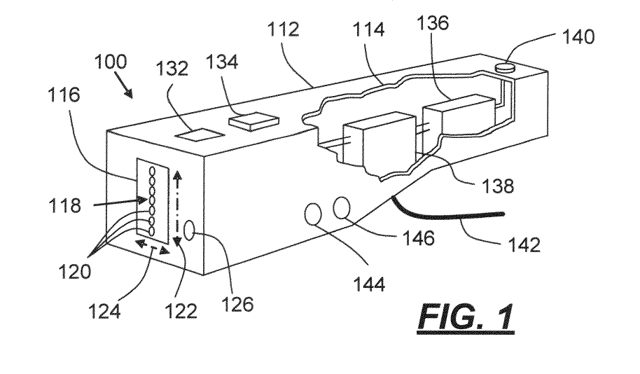

Referring now to FIG. 1, there is illustrated a hand-held printer 100 of the type which can incorporate the improvements described herein. FIG. 1 illustrates an embodiment of a hand-held printing apparatus 100. The printing apparatus 100 has a housing 112, and a cut-away window 114 is depicted in the housing 112 only for illustrative purposes in order to portray certain components inside the housing 112. The printing apparatus 100 has a micro-fluid ejection head 116. The ejection head 116 has a linear array 118 of micro-fluid ejection ports or nozzles 120. The linear array 118 has a longitudinal orientation depicted by reference arrow 122 and an orthogonal lateral orientation depicted by reference arrow 124. Printing apparatus 110 also contains a position sensor 126 that may be used to provide positional data regarding the position and translational motion of the printing apparatus 100.

Printing apparatus 100 may include a display 132 and a “PRINT” button 134 for activating the printing apparatus 100. The display 132 may be used to portray information regarding the image to be printed or a portion thereof, or to portray the status of the printer, or combinations of the foregoing and similar information The PRINT button 134 is used to provide a print enable signal to the printing apparatus 100 to cause fluid to be ejected from the ejection head 116 through the nozzles 120.

In the exemplary embodiment, the housing 112 of the printing apparatus 100 may include a power supply 136 and a microprocessor 138. An on/off button 140 may be provided, and a communication link 142 may be provided to transfer information to be printed from an external source such as a computer or personal digital assistant (PDA) device. Communication link 142 is portrayed in FIG. 1 as a wired link, but in alternative embodiments a wireless communication link may be used. Two print control dials 144 and 146 may be provided for the user of printing apparatus 100 to control various aspects of the printed image such as quality mode, color, and the like.

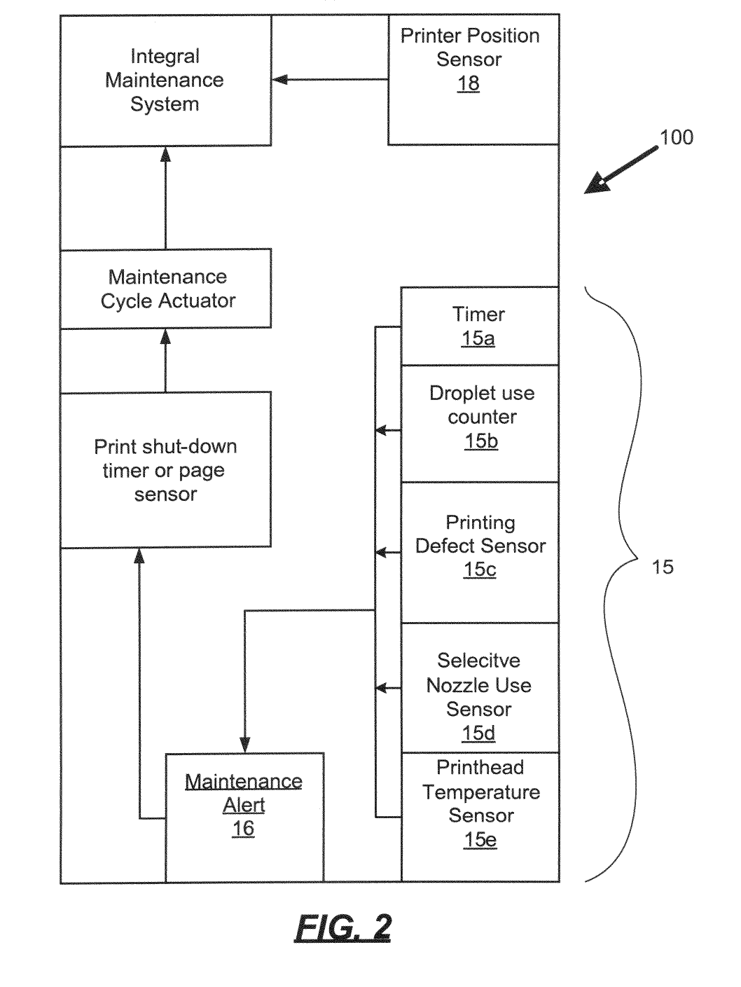

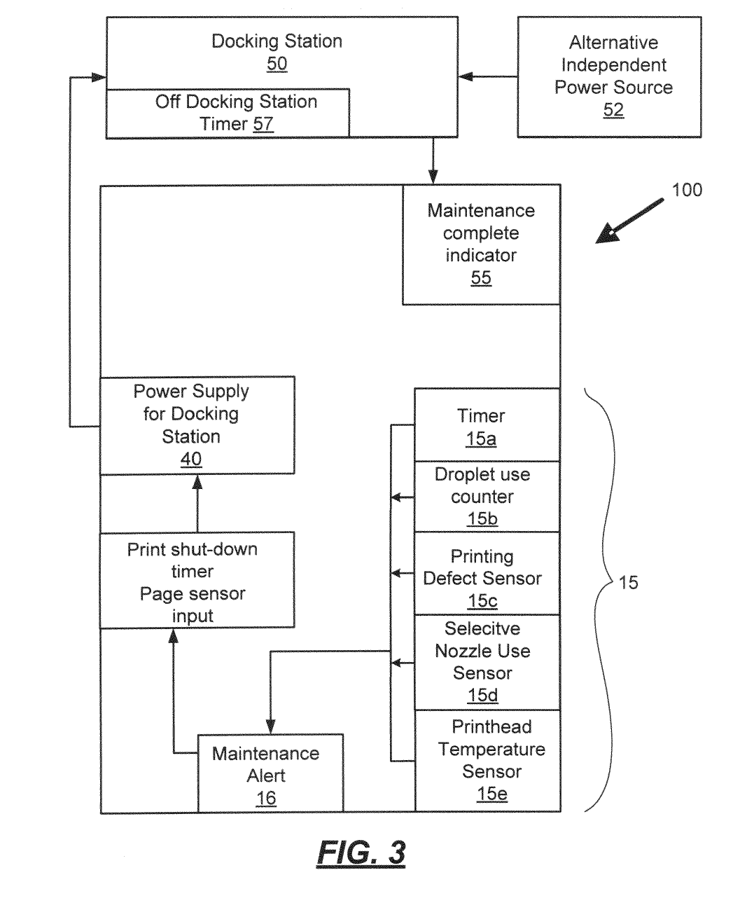

Referring now to FIG. 2 and FIG. 3 wherein there are illustrated, respectively, mechanical schematics of a hand-held printer having an integral maintenance system and a hand-held printer which utilizes a maintenance docking station. Hand-held printer 100 maintenance cycles may be triggered based on a sensor 15, such as a timer 15a, or a droplet counter 15b. For example, upon such a triggering, an alert 16 would advise the user to perform such a maintenance cycle after a certain elapsed time, or after a certain number of total drops have been fired onto a page. If the need for maintenance occurs while printing, maintenance shut down may be delayed so that it is effected a short time later. If the printer 100 were to shut down for maintenance while printing, depending on the position sensor 28 used and the method of navigation, it may not be possible to recalculate the printer position after such maintenance. Accordingly, in that event the printer 100 will not deactivate until the present print swath or page is completed. If it is desired to keep the printer position valid during performance of the maintenance cycle, the printhead may be wiped while the printer is stopped at its last print position, and the print nozzles may be exercised by spitting off to the side of the document or onto a disposable piece of paper.

Additional manners in which the need for maintenance may be detected are the determination of printing defects 15c; low usage of certain nozzles 15d; and printhead temperature control 15e. Because these conditions might come about during the printing of a page, the maintenance alert 16 is preferably a warning rather than a print stop actuator. Utilizing temperature control 15e would inform the user of printhead overheating, which would require that the requisite maintenance be performed while the printhead cools to an acceptable printing temperature. Monitoring printing defects 15c, such as missing nozzles, may also trigger the necessity to perform a maintenance cycle. This is particularly useful where the user sporadically uses the printer 100, which resets a maintenance timer 15a, but does not monitor the use of the nozzles.

As is known to those skilled in the art, printers may use an integral maintenance system as illustrated schematically in FIG. 2 or a separate docking station where maintenance is performed, such as illustrated in FIG. 3. When a separate docking station 50 is utilized, to enhance the maintenance operation the docking station may be electrically connected 51 to the printer 100 for communication reasons and to power the maintenance station. In the case of an electronically actuated maintenance station, the printer is coupled 51 to the maintenance station in order to operate, or to be enabled, after maintenance is finished. Such a docking station 50 may have a separate power source 52, or piggyback off of the printer's power supply 40 through the appropriate connector 51. Other means of communication between the hand-held printer 100 and the docking station 50 are a wireless or mechanical communication whereby the maintenance is purely mechanical, but an indicator 55 on the printer is energized so that completion of the requisite maintenance cycle is communicated to the hand-held printer 100 to enable further printing.

Because many users are believed to leave hand-held printers off a docking station thereby causing the printhead to dry up, hand-held printers 100 have a maintenance button. The function of the maintenance button is to initiate a protocol which will revive the printhead. However, many users fail to use such a maintenance button, or do not realize that the printer must be moved after the maintenance button is actuated, resulting in continued degradation of print quality. While some users put the printer back in the docking station to correct the situation, the printer may not be exercised by such placement and, accordingly, one or more nozzles may become clogged.

The embodiment of the present invention as illustrated in FIG. 3 obviates the problems of that present technology and uses a spit cup at the docking station, and an off-station timer that alerts the user when the printer 100 is off the docking station 50 for prolonged periods of time and not being used. When the printer 100 is locked into the docking station 50, the printer will stay locked until a maintenance operation is performed.

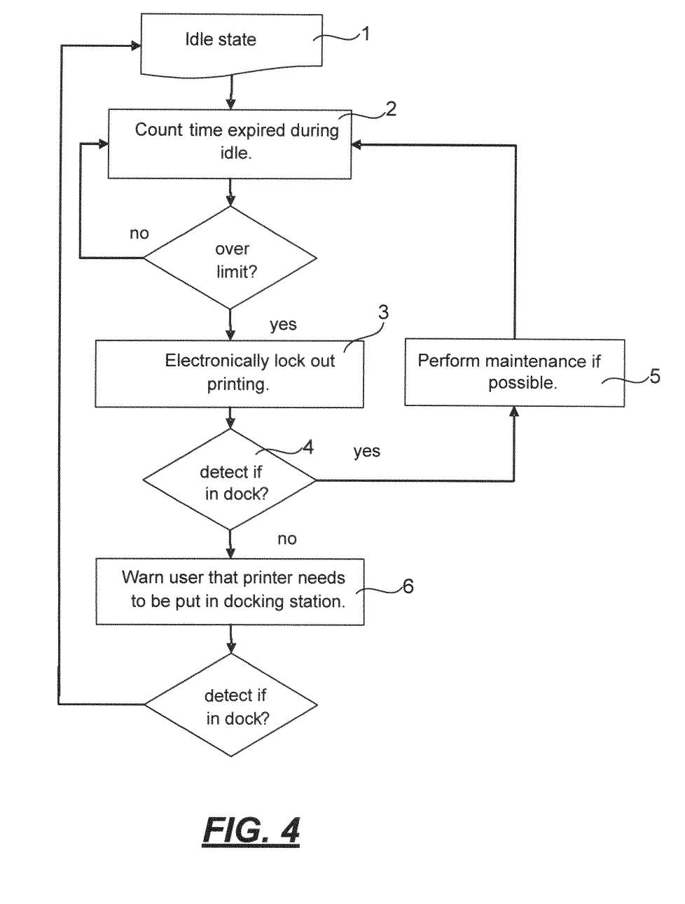

Referring now to FIG. 4, there is illustrated a flow diagram of a method for monitoring the maintenance of a hand-held printer 100 when such a hand-held printer is in a power-on idle state 1 prior to printing. If a pre-set time period has expired while idling 2, printing will be electronically locked out 3. If the predetermined time period has not expired the count will continue while printing. When the pre-determined count time has expired during idling, and the printer is electronically locked to prohibit printing, if the printer is determined to be positioned in a docking station 4 then maintenance will be performed 5. If the printer 100 is not determined to be positioned in a docking station, a signal or message will be generated informing the user that the printer is to be put into the docking station. When the printer 100 is then placed into the docking station in order to perform maintenance, the system will be reset and the printer will be in an idle mode of operation 1, awaiting a printing command. If a sufficient amount of time passes before printing is initiated, the count time may again expire requiring the initiation of a subsequent maintenance cycle before printing can be started.

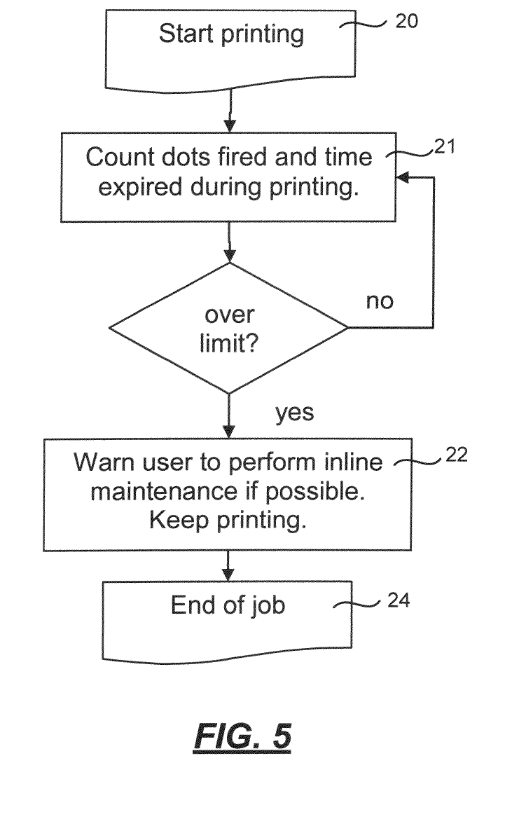

Referring now to FIG. 5, there is illustrated a flow diagram for printer operation when the printer 100 is in a print mode. The printer is engaged and printing started 20. After a pre-determined amount of total droplets have been fired onto the page, or a certain period of time has expired 21, the user will be warned 22 that it is time to perform in-line maintenance. The printer will continue printing, however, until the end of the print page 24. When the print page is completed, the printer 100 is to be put into the docking station for maintenance, or if equipped with an integral maintenance system, the maintenance cycle is initiated and the printer 100 returns to the idle mode.

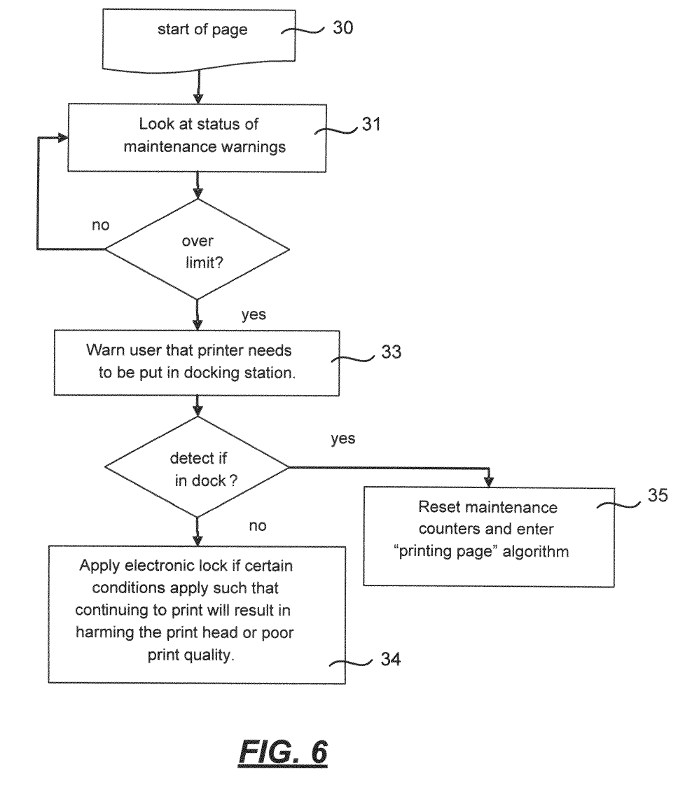

Referring now to FIG. 6, there is illustrated a flow diagram for a printer 100 beginning a printing operation on a new page, even if only partially through a desired complete print job. During the start of a page 30 the printer 100 will query maintenance status 31. If there are no indicia indicating that a maintenance operation is to be performed, printing will continue. In the event that a maintenance warning has been initiated 33, the operator will be advised that the printer 100 needs to be put in a docking station 34 for maintenance. When the printer is placed in the docking station, the detection of the printer 100 in the docking station 34 will reset the maintenance counters 35 as described with reference to FIG. 3. If the printer 100 is not placed into the docking station an electronic lock timer will be activated to terminate printing if it will result in an adverse effect on the printhead or the production of a poor quality print.

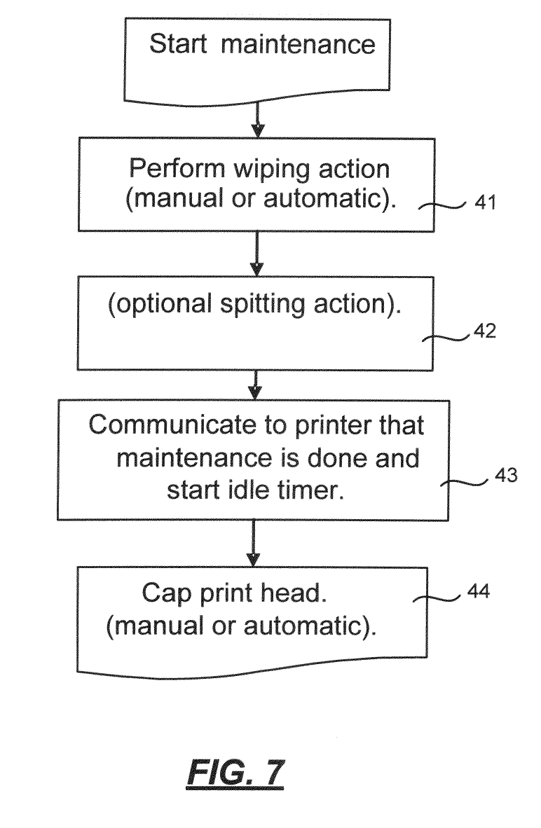

The maintenance which is performed on the printer is illustrated in the flow diagram of FIG. 7. When the maintenance cycle is initiated a wiping action, either manual or automatic, is performed on the printhead 41 and the inkjet nozzles are optionally exercised 42. A signal is coupled to the printer 43 when the requisite maintenance is complete, and the idle timer is then again initiated. The printhead may then be capped 44, either manually or automatically, and the printer is maintained in the idle mode as illustrated in FIG. 4 or begins printing in accordance with the flow diagram of FIG. 5 or 6.

As described herein, all of these flow diagrams are examples and various visual, audible or tactile signals can be employed to notify an operator that maintenance is required. In addition, the hand-held printer can be locked to a docking station either mechanically or electronically, or if an integral maintenance station is used deactivation of the print function can be effected through a mechanical linkage or electronically. It is contemplated, and it will be apparent to those skilled in the art from the preceding description and the accompanying drawings, that modifications and/or changes may be made to the embodiments of the disclosure. Accordingly, it is expressly intended that the foregoing description and the accompanying drawings are illustrative of exemplary embodiments only, not limiting thereto, and that the true spirit and scope of the present disclosure be determined by reference to the appended claims.

What is claimed is:

1. A method of maintaining print quality of a hand-held printer comprising the steps of:
alerting a user of a hand-held printer that preventive maintenance is required before print quality is sacrificed.

2. The method of claim 1 wherein said step of alerting the user of a hand-held printer that preventive maintenance is required is effected by generating a visible signal.

3. The method of claim 1 wherein said step of alerting the user of a hand-held printer that preventive maintenance is required is effected by generating an audible signal.

4. The method of claim 1 wherein said step of alerting the user of a hand-held printer that preventive maintenance is required is effected by generating a tactile signal.

5. The method of claim 4 wherein the step of generating a tactile signal comprises vibrating the hand-held printer.

6. The method of claim 1 wherein said step of alerting the user of a hand-held printer that preventive maintenance is required periodically occurs by timing the period in which said hand-held printer is in use.

7. The method of claim 1 wherein said step of alerting the user of a hand-held printer that preventive maintenance is required is effected by generating a signal in response to the number of total ink drops fired.

8. The method of claim 1 wherein said step of alerting the user of a hand-held printer that preventive maintenance is required is effected by generating a signal in response to the usage of selected nozzles.

9. The method of claim 1 wherein said step of alerting the user of a hand-held printer that preventive maintenance is required is effected by generating a signal in response to the temperature of selected ink nozzles.

10. A method of insuring that preventive maintenance is performed on a hand-held printer having an integral maintenance system comprising the steps of:
signaling the user of the hand held printer that preventive maintenance is required, and preventing printing operation of the hand-held printer until such preventive maintenance occurs.

11. A method of insuring that preventive maintenance is performed on a hand-held printer adapted to engage a docking station comprising the steps of:
inserting the hand-held printer into a maintenance docking station and retaining the hand-held printer therein until maintenance is performed.

12. The method of insuring that preventive maintenance is performed on a hand-held printer as set forth in claim 11 wherein the step of inserting the hand-held printer into the docking station comprises locking the hand-held printer into the docking station until the user performs a physical movement initiating the performance of the requisite preventive maintenance.

13. The method of claim 12 wherein said step of locking the hand-held printer into a docking station is effected by an electronic locking device.

14. The method of claim 12 wherein said step of locking the hand-held printer into a docking station is effected by a manual locking device.

15. In a hand-held printer wherein periodic maintenance is performed to maintain print quality, the improve ent comprising:
means for generating an alerting signal to alert the hand-held printer user that preventive maintenance is required.

16. The apparatus of claim 15 wherein said alerting signal is a visible signal.

17. The apparatus of claim 15 wherein said alerting signal is an audible signal.

18. The apparatus of claim 15 wherein said alerting signal is a tactile signal.

19. The apparatus of claim 19 wherein said tactile signal comprises vibrating said hand-held printer.

20. The apparatus of claim 15 wherein said alerting signal is generated periodically by timing the period in which said hand-held printer is in use.

21. The apparatus of claim 15 wherein said alerting signal is generated in response to the number of total ink drops fired by said hand-held printer.

22. The apparatus of claim 15 wherein said alerting signal is generated in response to the usage of selected nozzles of said hand-held printer.

23. The apparatus of claim 15 wherein said alerting signal is generated in response to the temperature of selected nozzles of said hand-held printer.

24. In a hand-held printer wherein periodic maintenance is performed by means of an integral maintenance system, the improvement comprising:
means for generating an alerting signal to signal the hand-held printer user that maintenance is required and preventing printing operation of the hand-held printer until such preventive maintenance is effected.

25. In a hand-held printer wherein a periodic maintenance is performed upon operatively connecting the hand-held printer to a maintenance docking station, the improvement comprising:
means for locking the hand-held printer to the maintenance docking system upon the generation of an alerting signal and retaining the hand-held printer coupled thereto until maintenance is performed.

26. The apparatus of claim 25 further including release means for releasing the hand-held printer from the docking station upon the hand-held printer user initiating a physical movement of the hand-held printer which initiates the performance of maintenance.

27. The apparatus of claim 26 further including an electronic locking means for locking the hand-held printer to the docking station.

28. The apparatus of claim 26 further including a manual locking means for locking the hand-held printer to the docking station.
